(19) United States
(12) Patent Application Publication
(10) Pub. No.: US 2013/0338354 A1
(43) Pub. Date: Dec. 19, 2013

(54) RENEWABLE SUPERABSORBENTS

(71) Applicants: Ann-Christine Albertsson, Saltsjoebaden (SE); Ulrica Edlund, Tyresoe (SE); Jens Voepel, Stockholm (SE)

(72) Inventors: Ann-Christine Albertsson, Saltsjoebaden (SE); Ulrica Edlund, Tyresoe (SE); Jens Voepel, Stockholm (SE)

(21) Appl. No.: 13/819,572

(22) PCT Filed: Aug. 29, 2011
(86) PCT No.: PCT/EP2011/064790

§ 371 Date: May 7, 2013

Related U.S. Application Data
(60) Provisional application No. 61/378,619, filed on Aug. 31, 2010.

(30) Foreign Application Priority Data
Aug. 30, 2010 (SE) 1050883-6

(51) Int. Cl. B01J 20/24

(52) U.S. Cl. CPC B01J 20/24
USPC 536/123.1

(57) ABSTRACT

There is disclosed a method for the manufacture of a crosslinked superabsorbent polymer material. There is further disclosed a crosslinked superabsorbent polymer material manufactured with the method. Using the new polymer material the previously used undesired chemistry based on polymerization of acrylamide is avoided and the less desired chemistry based on polymerization of on acrylic acid is significantly reduced. In addition the present polymer material is renewable. In contrast to the state of the art lignin does not have to be removed from the hydrolysate, so that energy, time and cost are saved and inexpensive raw materials and inexpensive process streams can be used. Lignin in the polymer material gives stronger bindings resulting in improved mechanical properties of the material. The presence of lignin further makes it possible to modify the hydrophilicity of the crosslinked polymer material. The raw materials are typically not valuable foodstuffs.

### TECHNICAL FIELD

The present invention relates generally to superabsorbent materials based on renewable hydrolysates. More specifically the present invention relates to a crosslinked polymer material derived from hydrolysates comprising hemicelluloses and having superabsorbent properties in water based fluids, and a method to produce such a crosslinked polymer material.

### BACKGROUND

Superabsorbent materials and their manufacture are well known. Superabsorbent polymers are suitable for many applications. The oil-based superabsorbents available today are for instance used in agriculture as water retaining additives in soil, as consistency formulating additives in cosmetics, or as water purification absorbents. An important application for superabsorbent particles is absorbing hygiene products.

Examples of commercial superabsorbent according to the state of the art include but are not limited to materials based on polyacrylic acid, a sodium salt of polyacrylic acid, or a co-polymer or a blend with polyacrylic acid where the gel chemistry is designed to bear ionic pendant groups. With their extraordinary hydrophilicity, these polyacrylic acid gels absorb and retain large amounts of water-based fluids. The cross-linking chemistry and the ionic strength are important parameters to vary and control to obtain an optimal degree of swelling in combination with sufficient strength and retention capacity. Polyacrylic acid is synthesized through free radical polymerization of acrylic acid, a monomer produced by oxidation of propylene, an important product from crude oil cracking.

According to the state of the art superabsorbent systems comprising acrylate are used within many areas including diapers and water purification.

WO 98/27117 describes polymeric superabsorbents comprising cellulose and/or starch and at least one component acting as a crosslinker by reacting with hydroxyl groups, such as epicholohydrin, diglycidyl ethers, or divinyl sulphone.

EP 1 268 557 B1 describes a SAP (polymeric superabsorbent) film formed from a polysaccharide, typically cellulose, and a polyethylene glycol.

WO 03/096946 discloses biodegradable environmentally friendly pants diaper comprising a starch based absorbent.

GB 86-15404 discloses absorbent vegetable materials for diapers and sanitary napkins and uses pectin from beetroots which is esterified and treated with ion exhanger in order to reach a high level of water absorption.

J. Voepel et al in J. Polym. Sci. A Polym. Chem., 2009, 47, 3595-3606, discloses coupling of alkenyl groups to hydroxyl groups on AcGGM in the manufacture of a crosslinked hydrophilic gel, which was not superabsorbent.

US 2003/0045707 discloses a superabsorbent polymer derived from a cellulosic, lignocellulosic, or polysaccharide material.

WO 2009/068525 describes a strategy for the recovery of polymeric material from a water based side stream, a so called wood hydrolysate, generated in the hydrothermal treatment of wood.

J. Voepel et al in J. Appl. Polym. Sci. 2009, 112, 2401-12, discloses the manufacture of hydrogels based on AcGGM. The raw material was purified using steps including ultrafiltration and freeze drying and thus the material was very pure. The swelling ratio Q of the product was measured and found to be between about 3-8. The maximum value of the swelling ratio was 8.1.

J. Voepel et al in Polymer Preprints, 2010, 51, 747-748, also discloses manufacture of hydrogels from AcGGM. The material was purified to a high degree using steps including ultrafiltration and lyophilization.

In the prior art it has hitherto been a prejudice that hydrogels based on polysaccharides from wood, plants etc should comprise as little lignin as possible, since it was believed that lignin would impair the properties of the hydrogel.

A problem in the prior art is that the raw material has to be purified which is energy consuming, time consuming and costly. In particular lignin has to be removed when using hydrolysate of wood, plants etc.

Another problem in the prior art regarding superabsorbents is that a chemistry based to a very high extent on polymerization of acrylamide and/or acrylic acid is used. This type of chemistry is undesired for instance because is it not renewable.

Another disadvantage in the prior art regarding hydrogels is that raw materials are used, which also may serve as human food. This is considered to be a waste of valuable food.

There is a raising concern regarding environmental issues such as climate changes. It is desired to give up non-renewable materials and instead change to renewable materials. Thus there is a desire to replace conventional plastic materials, typically thermoplastics based on oil-derived building blocks, with more environmentally-friendly alternatives.

Another problem in the state of the art is that materials which are actually based on renewable sources are very expensive.

### SUMMARY OF THE INVENTION

It is an object of the present invention to alleviate at least some of the disadvantages of the prior art and to provide a superabsorbent based on renewable sources as well as a method for its production. The inventors have unexpectedly found that by not removing lignin from lignin containing raw material it is possible to improve the properties of the polymer material.

In a first aspect there is provided method for the manufacture of a crosslinked polymer material, said method comprising the steps of:

a) providing a hydrolysate comprising at least one oligo- and/or polysaccharide,
b) separating the hydrolysate to obtain a fraction rich in oligo- and/or polysaccharide, wherein said fraction comprises 2-15 wt % lignin,
c) modifying at least a part of the at least one oligo- and/or polysaccharide by covalently binding at least one of i) a ionisable compound to a hydroxyl group on the at least one oligo- and/or polysaccharide, wherein the at least one ionisable compound is charged at least in the pH interval from pH 5 to pH 8, and ii) N-vinylpyrrolidone to a hydroxyl group on to the at least one oligo- and/or polysaccharide, and crosslinking at least a part of the modified oligo- and/or polysaccharide.

In a second aspect there is provided a crosslinked polymer material comprising covalently crosslinked oligo- and/or polysaccharides, wherein at least one hydroxyl group on said oligo- and/or polysaccharides is covalently bound to a ionizable compound, and wherein the at least one ionizable compound is charged at least in the pH interval from pH 5 to pH 8, and wherein the polymer material comprises lignin.

An advantage of the invention is that the undesired chemistry based on polymerization of acrylamide is avoided and the less desired chemistry based on polymerization of on acrylic acid is significantly reduced. In addition the present polymer material is renewable.

Another advantage is that the raw material does not have to be purified, so that energy, time and cost are saved. Lignin does not have to be removed in the hydrolysate, which means that inexpensive raw materials and inexpensive process streams can be used.

A further advantage is that the lignin in the polymer material gives stronger bindings resulting in improved mechanical properties of the material.

Due to the fact that lignin is more hydrophobic than the oligo- and/or polysaccharide in the hydrolysate, it is possible to modify the hydrophilicity of the crosslinked polymer material. This in turn will give the advantage of an improved possibility of mixing other substances with the crosslinked polymer material and fine tuning the hydrophilicity of the material depending on the intended use of the crosslinked polymer material. The storage life of the crosslinked polymer material is further improved with lignin.

The raw materials which are used for the present process are typically not foodstuffs and they usually do not serve as human food. Thus valuable food is not consumed as raw material for the process.

By using the present invention it is possible to manufacture a superabsorbent gel based on renewable raw materials and keep the raw material cost as well as the manufacturing costs acceptable. By the present process it is possible to utilize easy accessible raw materials from existing processes.

### BRIEF DESCRIPTION OF THE DRAWINGS

The invention is described with reference to the following drawings in which:

FIG. 1 shows preparation of a crosslinked polymeric material according to example 5 and 6, and

FIG. 2 shows preparation of crosslinked polymeric materials according to examples 5, 9, 10, 13 and 14.

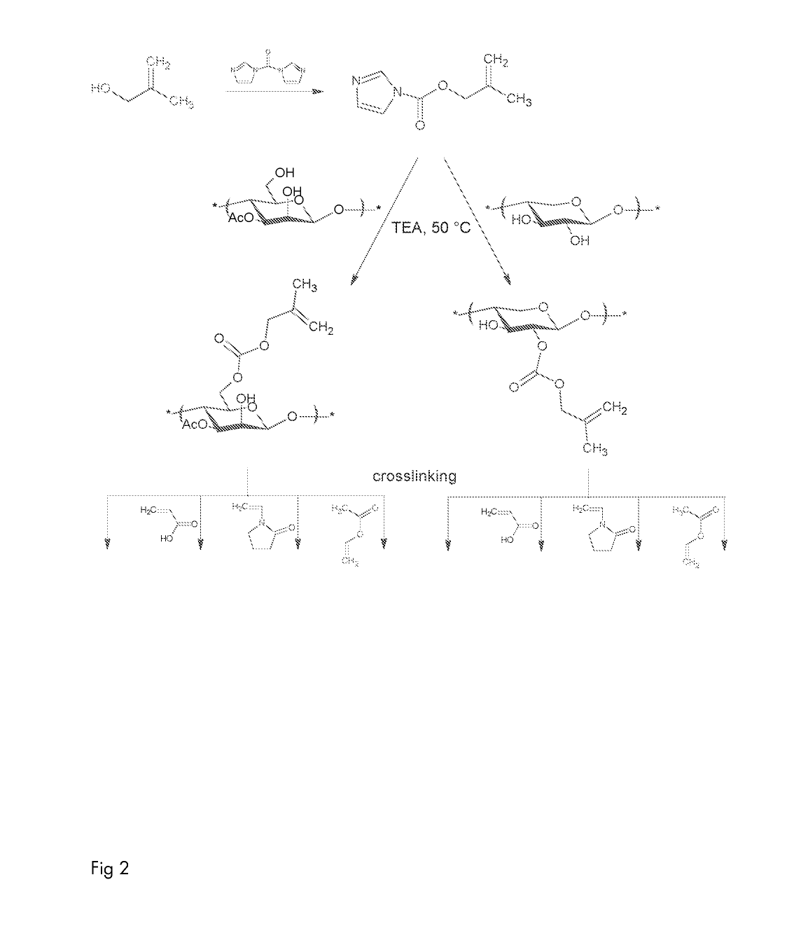

### DETAILED DESCRIPTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

The term “about” as used in connection with a numerical value throughout the description and the claims denotes an interval of accuracy, familiar and acceptable to a person skilled in the art. Said interval is ±10%.

As used throughout the claims and the description, the term “gel” denotes a material comprising a solid polymer network surrounded by a liquid medium. The crosslinked polymer material according to the invention is thus a gel.

As used throughout the claims and the description, the term “hydrogel” denotes a gel where the liquid medium is water or a water based liquid. The crosslinked polymer material according to the invention is thus also a hydrogel.

As used throughout the claims and the description, the term “hydrolysate” denotes a water phase comprising oligosaccharides and/or polysaccharides.

As used throughout the claims and the description, the term “oligosaccharide” denotes a shorter polymeric carbohydrate structure containing sugars components.

As used throughout the claims and the description, the term “oligo- and/or polysaccharide” denotes either oligosaccharides or polysaccharides or alternatively it denotes a mixture of oligosaccharides and polysaccharides. Thus the term means at least one selected from oligosaccharides and polysaccharides.

As used throughout the claims and the description, the term “polysaccharide” denotes linear or branched polymeric carbohydrate structures, formed of repeating units (either mono- or disaccharides) joined together by glycosidic bonds.

As used throughout the claims and the description, the term “a fraction rich in” in connection with a separation denotes a fraction with higher concentration of a compound compared to other fractions. Thus a fraction rich in oligo- and/or polysaccharide, comprises a higher concentration of oligo- and/or polysaccharide compared to other fractions from the separation.

As used throughout the claims and the description, the term “superabsorbent material” denotes a material with the ability to absorb and retain large relative amounts of liquid. Superabsorbent materials have a swelling ratio (Q) from 10 to several hundred or more. The superabsorbent does not dissolve in the liquid. Often a superabsorbent material comprises a crosslinked network of a hydrophilic polymer so that the hydrophilic character causes the material to absorb water while the crosslinks prevent the said material from dissolving, instead, the network swells, thereby increasing its volume.

As used throughout the claims and the description, the term “swelling ratio (Q) is determined according to the equation: Q=(mₜ−m₀)/m₀. Where m₀ is the weight of the dried gel and mₜ is the weight of the gel after immersion into an excess of deionized H₂O (or alternatively a water based fluid) at room temperature and its weight recorded at time t by carefully removing the gel from the water (or alternatively a water based fluid) and gently removing the surface water (or alternatively a water based fluid) with a filter.

There is disclosed the preparation of crosslinked polymer material based on any of various hydrolysates, each reacted as described below with one or several co-components and crosslinked.

In a first aspect there is provided a method for the manufacture of a crosslinked polymer material, said method comprising the steps of:

a) providing a hydrolysate comprising at least one oligo- and/or polysaccharide,
b) separating the hydrolysate to obtain a fraction rich in oligo- and/or polysaccharide, wherein said fraction comprises 2-15 wt % lignin,
c) modifying at least a part of the at least one oligo- and/or polysaccharide by covalently binding at least one of i) a ionisable compound to a hydroxyl group on the at least one oligo- and/or polysaccharide, wherein the at least one ionisable compound is charged at least in the pH interval from pH 5 to pH 8, and ii) N-vinylpyrrolidone to a hydroxyl group on to the at least one oligo- and/or polysaccharide, and crosslinking at least a part of the modified oligo- and/or polysaccharide.

In an alternative embodiment the hydrolysate comprises 4-15 wt % lignin. In yet another embodiment the hydrolysate comprises 2-10 wt % lignin. In another embodiment the hydrolysate comprises 3-12 wt % lignin.

The lignin is bound to the at least one oligo- and/or polysaccharide. A hydrolysate comprising lignin which is bound to the at least one oligo- and/or polysaccharide gives advantages since the lignin does not have to be removed during an additional purification step.

In one embodiment the raw material for the process is at least one selected form wood, cereal straw, various parts of plants including but not limited to roots, stems, leaves, and seeds. Algae and fruits are included as further non limiting examples of raw materials. In-expensive and industrially easily available in all processed lignocellulosic feedstock such as processed wood and plant residues in the food industry, including but not limited to brewer's spent grain, peel, and grain and seeds.

Examples of sources of the hydrolysate include but are not limited to cocoa pods, kiwi fruits, spruce, and birch.

In one embodiment the hydrolysate comprises a hydrolysate based on at least one selected from wood and plant material. In one embodiment the hydrolysate comprises a hydrolysate based on wood. In one embodiment the hydrolysate comprises a hydrolysate based on straw. In one embodiment the hydrolysate comprises a hydrolysate based on cocoa shells. In one embodiment the hydrolysate is obtained from a process in which wood or other plants are being processed. In one embodiment the hydrolysate is based on wood. A wood hydrolysate is in one embodiment obtained from the process in conventional pulping industries, providing good access to this raw material, which as is also renewable. The hydrolysate is in one embodiment collected as the water soluble phase from a process in which the cellulose is not in the water soluble phase but used to make a product in the said process. The water-soluble phase, the hydrolysate, typically comprises oligo- and polysaccharides, and most typically hemicelluloses as the main component. Lignin is present in the hydrolysate. In one embodiment of the present invention, a wood hydrolysate is collected from a wood processing unit and optionally separated into different fractions based on solubility or molecular weight. For example, membrane filtration of a crude hydrolysate enables the fractionation into a higher and one lower molecular weight fraction.

In one embodiment a wood based hydrolysate is collected and kept for later separation. In one embodiment the hydrolysate is kept at a temperature below 0° C., preferably below −10° C.

In one embodiment the separation of the hydrolysate is performed with regard to molecular weight. In another embodiment the separation of the hydrolysate is performed with regard to solubility. In yet another embodiment the separation of the hydrolysate is performed by a combination of separation with regard to solubility and separation with regard to molecular weight. In one embodiment the separation is performed with membrane filtration. In one embodiment the separation is performed so that molecules with a molecular weight of 1000 g/mol or higher are retained. The skilled person can separate hydrolysates with regard to solubility and/or molecular weight using known methods.

In one embodiment at least a part of the oligo- and/or polysaccharides are modified by reaction with a compound prior to the crosslinking. In one embodiment at least a part of the oligo- and/or polysaccharides are modified by reaction with an alkenyl compound prior to the crosslinking.

In one embodiment at least a part of the oligo- and/or polysaccharides are crosslinked by radical polymerization. In one embodiment at least a part of the oligo- and/or polysaccharides are crosslinked by ionic polymerization. In one embodiment at least a part of the oligo- and/or polysaccharides are crosslinked by coordination polymerization. In an alternative embodiment a combination of more than one polymerization method is used.

In one embodiment a crosslinker is used to obtain covalent binding between at least a part of the oligo- and/or polysaccharides, and an additional compound is present at least during the crosslinking reaction, said compound comprising at least one C═C double bond and at least one selected from a primary and a secondary hydroxyl group. In another embodiment a crosslinker is used to obtain covalent binding between at least a part of the oligo- and/or polysaccharides, and an additional compound is present at least during the crosslinking reaction, said compound comprising at least one C═C double bond and at least one selected from a primary and a secondary hydrophilic group. In a further embodiment a crosslinker is used to obtain covalent binding between at least a part of the oligo- and/or polysaccharides, and acrylic acid or N-vinyl pyrrolidone is present at least during the crosslinking reaction. In yet another embodiment a crosslinker is used to obtain covalent binding between at least a part of the oligo- and/or polysaccharides, and methacrylic acid is present at least during the crosslinking reaction. In still a further embodiment a crosslinker is used to obtain covalent binding between at least a part of the oligo- and/or polysaccharides, and a vinyl amine is present at least during the crosslinking reaction. Alternatively a combination of the different additives is used at least during the crosslinking reaction. In yet another embodiment a crosslinker is used to obtain covalent binding between at least a part of the oligo- and/or polysaccharides, and vinyl acetate is present at least during the crosslinking reaction followed by hydrolysis of acetate groups to hydroxyl groups yielding polyvinyl alcohol crosslink chains.

In one embodiment the at least one ionizable compound is selected from the group consisting of maleic anhydride and citric acid.

In one embodiment the method further comprises a step wherein the degree of swelling of the crosslinked polymer material in water is evaluated.

In a second aspect there is provided a crosslinked polymer material comprising covalently crosslinked oligo- and/or polysaccharides, wherein at least one hydroxyl group on said oligo- and/or polysaccharides is covalently bound to a ionizable compound, and wherein the at least one ionizable compound is charged at least in the pH interval from pH 5 to pH 8, wherein the polymer material comprises lignin.

In one embodiment the crosslinked polymer material displays a swelling ratio (Q) of 10 or more. In another embodiment the crosslinked polymer material displays a swelling ratio (Q) of 15 or more. In another embodiment the crosslinked polymer material displays a swelling ratio (Q) of 20 or more. In yet another embodiment the crosslinked polymer material displays a swelling ratio (Q) of 22 or more.

In one embodiment the crosslinked polymer material is biodegradable. Biodegradable means that the polymer material has the ability to be degraded in nature, for instance by naturally occurring enzymes. In one embodiment the biodegradable polymer material does not comprise acrylic groups.

In one embodiment the crosslinked polymer material is at least partly surrounded by at least one another material. In one embodiment the crosslinked polymer material is at least partly surrounded by at least one another material to form an article selected from a sanitary product for absorbing body fluids, a diaper, an incontinence pad, a sanitary towel, a panty liner, a water filter, and a water retaining coating around a seed.

In an alternative embodiment the method for the manufacture of a crosslinked polymer material, comprises the steps of:

a) providing a hydrolysate comprising at least one oligo- and/or polysaccharide,
b) separating the hydrolysate to obtain a fraction rich in oligo- and/or polysaccharide, wherein said fraction comprises 2-15 wt % lignin,
c) modifying at least a part of the at least one oligo- and/or polysaccharide by covalently binding at least one ionisable compound to a hydroxyl group on the at least one oligo- and/or polysaccharide, wherein the at least one ionisable compound is charged at least in the pH interval from pH 5 to pH 8, and crosslinking at least a part of the modified oligo- and/or polysaccharide.

In an alternative embodiment the crosslinked polymer material comprises covalently crosslinked oligo- and/or polysaccharides, wherein at least one hydroxyl group on said oligo- and/or polysaccharides is covalently bound to at least one ionisable compound, and wherein the at least one ionisable compound is charged at least in the pH interval from pH 5 to pH 8, and wherein said polymer material comprises lignin.

Possible application areas thus include but are not limited to i) absorbing hygiene products, diapers, sanitary pads, ii) agricultural applications such as water-holding additives to soil, sustained release formulations for pesticides, growth hormones, growth retardants, insecticides etc, and iii) drying powder.

### EXAMPLES

### Measurement methods

### Chemical Structure

Nuclear Magnetic Resonance (NMR). The material compositions were determined by ¹H NMR spectroscopy. The spectra were recorded on a Bruker Avance DPX-400 NMR spectrometer operating at 400.13 MHz. The samples were prepared by dissolving in deuterated water (D₂O) or d₆-DMSO in a 5 mm diameter sample tube. Non-deuterated solvent was used as an internal standard.

Fourier Transform Infrared Spectrometry (FTIR) spectra were recorded on a Perkin Elmer Spectrum 2000 FTIR equipped with an Attenuated Total Reflectance (ATR) crystal accessory (Golden Gate) allowing the samples to be analyzed in the solid state. All spectra were calculated means from 16 scans at 2 cm⁻¹ resolution with correction for atmospheric water and carbon dioxide.

### Degree of Swelling

The terms gel and hydrogel is also used to denote the crosslinked polymer material according to the invention. The gels degree of swelling was determined by comparing the gel dry weight to the gel in the swollen state in the following manner: The dried gels were first weighed (m₀). Then the gels were immersed into an excess of deionized H₂O at room temperature and their weight recorded at various time points (mₜ) by carefully removing the gels from the water and gently removing the surface water with filter paper. The swelling ratio (Q) was then determined according to the equation: Q=(mₜ−m₀)/m₀ where t=3 days was defined as the equilibrium swelling ratio, Q_{eq}. All gels were evaluated in triplets and the mean Q was then calculated.

### Measurement Methods

### Carbohydrate Analysis

Carbohydrate analysis was performed by acid hydrolysis. The hydrolysates were diluted with a mixture of 6 ml of 72% H₂SO₄ (aq) in 84 ml of deionized water and kept in an autoclave at 125° C. for 1 h. Samples were then filtrated through fiber glass filter, washed with deionized water, diluted with deionized water to a volume of 100 ml, and finally analyzed by High Performance Anion Exchange Chromatography (HPAEC-PAD, Dionex ICS-3000). The filters used in the acid hydrolysis as described above were used to determine the Klason lignin content by washing the filters two times with 100 ml deionized water and then drying them at 105° C. for about 12 hours. The Klason lignin content was determined gravimetrically from the filter weight prior to filtration and after drying.

The following embodiments of the present invention includes the preparation of superabsorbent hydrogels based on any of various hydrolysates, The hydrolysates described in examples 1-4 below were prepared to constitute examples of raw material used in the preparation of superabsorbent gels. The hydrolysate components were then reacted with one or several co-monomers and cross-linked as described in examples 5-14.

### Example 1

A hydrolysate comprising O-acetyl-galactoglucomannan (AcGGM) as the main component was obtained from spruce (picea abies). AcGGM is a polysaccharide. Process water was extracted from thermo mechanical pulping (TMP) of spruce chips and first subjected to centrifugation to remove fiber residues. The lignin content was measured and was found to be about 2 wt %. The water phase was then concentrated by ultrafiltration, using a cellulosic membrane with a cut-off of 1000 g/mol. The retentate was diluted to ten times the original volume with water and once again ultrafiltrated. The retentate was finally freeze dried at reduced pressure and −57° C., yielding an off-white fluffy product. The major component was hemicelluloses (>90%) of the galactoglucomannan type. The carbohydrate composition of the AcGGM isolate was 15% glucose, 63% mannose, 17% galactose, and minor amounts of xylan and arabinose (4%) and had an average molecular weight of about 10000 g mol⁻¹, a PDI of ˜1.3 and a degree of acetylation (DSAc) of 30%.

### Example 2

A wood hydrolysate was prepared from softwood (pine and spruce) chips in an industrial process for fiberboard production. The fiberboard mill waste-water, a hydrolysate, was first subjected to centrifugation to remove fiber residues and other solid particles. The lignin content was measured and was found to be about 8 wt %. After this, the waste-water was ultrafiltrated using a tangential flow filtration cartridge unit equipped with a regenerated cellulose membrane (PLAC Prepscale, Millipore) with a nominal cut-off 1000 Da. In the filtration step, the waste-water was concentrated approximately 10 times, giving around 8% retentate (a hemicellulose rich fraction) and 92% permeate (fraction with low molecular weight organic compounds and inorganic salts). The retentate was further purified by solvent fractionation in ethanol yielding a high-molecular weight fraction comprising 85% of oligo- and polysaccharides and some lignin (with respect to dry matter). The retentate was finally freeze dried. The resulting hydrolysate fraction had an average molecular weight of about 6600 g/mol and a degree of acetylation (DSAc) of 50%.

### Example 3

A wood hydrolysate was prepared from spruce, picea abies. Industrial spruce chips were firstly screened by passing a laboratory screen grid at 8 mm but not 7 mm holes. The chips were then steamed at 110-120° C. for 45 min in a batch autoclave after which preheated water was added to a liquid:wood ratio of 6:1 (volume:mass ratio). The treatment temperature was then kept at 150-170° C. A representative heating time was 40 min, while the treatment time was 60 min. The resulting liquid phase had a pH from 3.3 to 4.0. The lignin content was measured and was found to be about 9 wt %. The liquid phase collected after hydrothermal treatment was then subjected to membrane filtration using a tangential flow filtration cartridge unit equipped with a regenerated cellulose membrane (PLAC Prepscale, Millipore) with a nominal cut-off 1000 g/mol. After ultrafiltration, the retentate phase was collected, diluted with water and once again subjected to ultrafiltration (diafiltration). The resulting retentate phase was finally freeze dried. The major component (85-89%) was hemicelluloses type oligo- and polysaccharides. The hydrolysate had an average molecular weight of about 4600 g/mol and a degree of acetylation (DSAc) of 50%.

### Example 4

A wood hydrolysate was generated in a pulping involving the sodium sulphite cooking of birch chips. The birch chips were first pre-treated at 100° C. for 15-20 minutes and then subjected cooking chemicals and heat (around 160-170° C.) to produce a red liquor under alkaline conditions (pH=8-11). In the dewatering step of the pulp after the initial step of cooking a liquid phase, a slurry containing polysaccharides, some lignin and some other low molecular wood components was removed from the cooking liquor. The lignin content was measured and was found to be about 9 wt %. This liquid phase was subjected to membrane filtration using a ceramic membrane with a cut-off of 5000 g/mol. The hydrolysate comprised to around half (with respect to dry matter) polysaccharides of the hemicelluloses xylan type. The hydrolysate had an average molecular weight of about 10000-13000 g/mol.

### Example 5

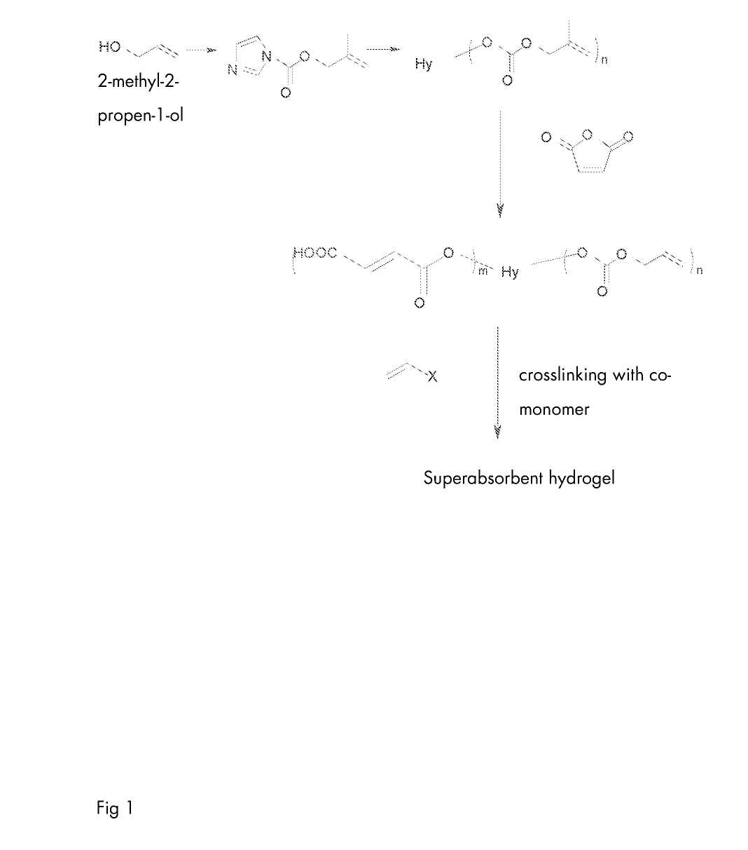

A hydrolysate from example 1-4 or highly purified xylan (commercial, received from Sigma) is reacted with 2-methyl-2-propylene-1-ol, as shown in FIG. 1 with “Hy” symbolizing the oligo- and polysaccharide chains in the hydrolysate. The 2-methyl-2-propylene-1-ol was first reacted with a slight excess of N,N′-carbonyl diimidazole (CDl) (a typical example is 90 mmol with 100 mmol CDl) in anhydrous CHCl₃ for various times to produce hydrolysates with different substitution amounts. The crude product was purified by washing with water and recovered by rotary evaporation. The purified and then dried product was then reacted with the hydrolysate at 50° C. by mixing them in DMSO in a 2:1 (mol:mol) ratio and adding triethylamine as a catalyst. The reaction time is typically between 3 and 200 h. A longer reaction time gives a higher degree of substitution (DS) as measured by NMR. The reaction time needed to reach a certain DS depends on the nature of the hydrolysate Some reaction times and resulting degrees of substitution is shown in Table 1.

| | Hydrolysate | | | |
|---|---|---|---|---|
| Reaction | AcGGM from | Xylan | Softwood | Birch from |
| time (h) | Example 1 | (Sigma) | from Example 2 | Example 4 |
| 16 | 0.95 | 0.091 | 0.08 | 0.21 |
| 23 | 1.04 | 0.17 | 0.15 | 0.42 |
| 45 | — | — | 0.59 | 0.56 |

The reaction mixture is then precipitated in an excess of a suitable non-solvent (2-propanol, ethyl acetate, water) and the precipitate is separated, washed and then dried. In the last step, the reacted hydrolysate is crosslinked by radical polymerization both in the presence and in the absence of a co-monomer, either acrylic acid or vinyl pyrrolidone. Mixtures of co-monomers are also conceivable. Typically, this is done in water solution by dissolving the reacted hydrolysate and then adding water solutions (1% w/w) of ammonium peroxodisulfate and sodium pyrosulfite. An alternative is crosslinking in DMSO. The resulting solutions are crosslinked at 60° C. for at least 6 h. The resulting material is soaked in water to leach out unreacted species and then dried at room temperature. A hydrogel prepared according to this protocol from a hydrolysate according to Example 1 and with 13.5 hours of reaction time in the second step showed a degree of swelling in water, Q, of 22.

### Example 6

Prepared as described in Example 5 but before crosslinking, the hydrolysate is also reacted with maleic anhydride. The reacted hydrolysate was then mixed with maleic anhydride in a 1:0.2-1 ratio (mol:mol) in DMSO together with triethylamine as a catalyst. The reaction was carried out for 1 h at 50° C. The reaction mixture was then precipitated in an excess of water and the precipitate was separated, washed and then dried.

### Example 7

Prepared as described in Example 6 but the reaction mixture was precipitated in an excess of 2-propanol and the precipitate was separated, washed and then dried.

### Example 8

Prepared as described in Example 6 but the reaction mixture was precipitated in an excess of ethyl acetate and the precipitate was separated, washed and then dried.

### Example 9

Prepared as described in Example 5 but with acrylic acid present as a co-monomer in the crosslinking step. The ratio of reacted hydrolysate to co-monomer can range from 10:90 to 90:10 (with respect to dry weight). To the water solution of reacted hydrolysate, the co-monomer is then added before the initiators are added. Crosslinking is done at elevated temperature as previously described. A hydrogel prepared according to this protocol from a hydrolysate according to Example 1, with 23 hours of reaction time in the second step, and with a hydrolysate to co-monomer ratio of 60:40 showed a degree of swelling in water, Q, of 15.6.

### Example 10

Prepared as in Example 5 but with anionic crosslinking instead of radical crosslinking and with acrylic acid present as a co-monomer in the crosslinking step. The ratio of reacted hydrolysate to co-monomer can range from 10:90 to 90:10 (with respect to dry weight). To a DMSO solution of reacted hydrolysate, the co-monomer is added before the initiator is added. Crosslinking is done at room temperature as previously described.

### Example 11

Prepared as described in Example 5 but with methacrylic acid present as a co-monomer in the crosslinking step.

### Example 12

Prepared as described in Example 5 but with a vinyl amine present as a co-monomer in the crosslinking step.

### Example 13

Prepared as described in Example 5 but with N-vinylpyrrolidone present as a co-monomer in the crosslinking step.

### Example 14

Prepared as described in Example 5 but with vinyl acetate present as a co-monomer in the crosslinking step. After crosslinking, soaking and drying as previously described, the product was immersed in water with NaOH (0.1M) and reacted through a saponification catalyzed with trace amounts of sodium methanoate to hydrolysate the acetate groups to hydroxyl groups. The product is rinsed in water until neutral and dried.

### Example 15

Prepared as described in Example 5 but reacted with allyl alcohol instead of 2-methyl-2-propylene-1-ol in the second step and with acrylic acid present as a co-monomer in the crosslinking step. After crosslinking, soaking and drying as previously described.

### Example 16

Comparision of swelling values Q.

| | Degree of | | Amount of | |
|---|---|---|---|---|
| | substitution, | | co- | Degree of |
| | DS (vinyl | | monomer | swelling, |
| Gel resource | alcohol) | Co-monomer | [% w/w] | Q |
| AcGGM | 0.23 | Acrylic acid | 40 | 6 |
| hydrolysate from | | | | |
| Example 1 | | | | |
| AcGGM | 0.15 | — | — | 22 |
| hydrolysate from | | | | |
| Example 1 | | | | |
| Pure AcGGM | 0.15 | — | — | 3.7 |
| (comparative) | | | | |
| Pure AcGGM^{b} | 0.15 | Hydroxyethyl | 40 | 4.2 |
| (comparative) | | methacrylate | | |
| Pure AcGGM^{b} | 0.15 | Hydroxyethyl | 60 | 6.8 |
| (comparative) | | methacrylate | | |
| Softwood | 0.38 | — | — | 7 |
| hydrolysate from | | | | |
| Example 2^{c} | | | | |
| Softwood | 0.07 | Hydroxyethyl | 35 | 17 |
| hydrolysate from | | methacrylate | | |
| Example 2^{c} | | | | |
| Birch hydrolysate | 0.42 | Acrylic acid | 40 | 15.6 |
| from Example 4 | | | | |
| Pure xylan | 0.56 | Acrylic acid | 40 | 4.4 |
| (Sigma-Aldrich) | | | | |
| (comparative) | | | | |
| Pure xylan | 0.56 | Vinyl | 40 | 4.9 |
| (Sigma-Aldrich) | | pyrrolidone | | |
| (comparative) | | | | |

^{b}Reacted with hydroxyethyl methacrylate instead of with 2-methyl-2-propylene-1-ol in the second step.
^{c}Reacted with hydroxyethyl methacrylate instead of with 2-methyl-2-propylene-1-ol in the second step.

### Example 17

Mechanical Strength and Rheology of the Material

A gel prepared from a hydrolysate from example 2 with hydroxyethyl methacrylate as the co-monomer had a shear modulus in the order of 17 kPa as measured by an ARES Rheometer (TA instruments). A comparison can be made with the corresponding gels made from a sample of pure AcGGM hemicellulose where gels with hydroxyethyl methacrylate as the co-monomer had a shear modulus around 3−5 kPa.

1.-25. (canceled)

26. A method of manufacturing a crosslinked polymer material, said method comprising the steps of:
a) providing a hydrolysate comprising at least one oligo- and/or polysaccharide;
b) separating the hydrolysate to obtain a fraction rich in the at least one oligo- and/or polysaccharide, wherein said fraction comprises 2-15 wt % lignin;
c) modifying at least a part of the at least one oligo- and/or polysaccharide in said fraction by covalently binding at least one ionisable compound to a hydroxyl group on the at least one oligo- and/or polysaccharide, wherein the at least one ionisable compound is charged at least in the pH interval from pH 5 to pH 8; and
d) crosslinking at least a part of the modified oligo- and/or polysaccharide produced in step (c).

27. The method according to claim 26, wherein said hydrolysate comprises hydrolysate based on wood.

28. The method according to claim 26, wherein said hydrolysate is obtained from a process in conventional pulping.

29. The method according to claim 26, wherein the separating step is performed with regard to molecular weight.

30. The method according to claim 26, wherein the separating step is performed with regard to solubility.

31. The method according to claim 26, wherein the separating step is performed with membrane filtration.

32. The method according to claim 26, wherein the separating step is performed so that molecules with a molecular weight of 1000 g/mol or higher are retained.

33. The method according to claim 26, wherein the at least a part of the oligo- and/or polysaccharides are modified by reaction with an alkenyl compound.

34. The method according to claim 26, wherein the at least a part of the oligo- and/or polysaccharides are modified by reaction with N-vinylpyrrolidone.

35. The method according to claim 26, wherein the at least a part of the oligo- and/or polysaccharides are crosslinked by radical polymerization.

36. The method according to claim 26, wherein the at least a part of the oligo- and/or polysaccharides are crosslinked by ionic polymerization.

37. The method according to claim 26, wherein the at least a part of the oligo- and/or polysaccharides are crosslinked by coordination polymerization.

38. The method according to claim 26, wherein said crosslinking step d) comprises the use of a crosslinker to obtain covalent binding between the at least a part of the modified oligo- and/or polysaccharides produced in step c), and wherein an additional compound is present at least during the crosslinking reaction, said compound comprising at least one C═C double bond and at least one selected from a primary and a secondary hydroxyl group.

39. The method according to claim 26, wherein said crosslinking step d) comprises the use of a crosslinker to obtain covalent binding between the at least a part of the modified oligo- and/or polysaccharides produced in step c), and wherein an additional compound is present at least during the crosslinking reaction, said compound comprising at least one C═C double bond and at least one selected from a primary and a secondary hydrophilic group.

40. The method according to claim 26, wherein said crosslinking step d) comprises the use of a crosslinker to obtain covalent binding between the at least a part of the modified oligo- and/or polysaccharides produced in step c), and wherein acrylic acid is present at least during the crosslinking reaction.

41. The method according to claim 26, wherein said crosslinking step d) comprises the use of a crosslinker to obtain covalent binding between the at least a part of the modified oligo- and/or polysaccharides produced in step c), and wherein methacrylic acid is present at least during the crosslinking reaction.

42. The method according to claim 26, wherein said crosslinking step d) comprises the use of a crosslinker to obtain covalent binding between the at least a part of the modified oligo- and/or polysaccharides produced in step c), and wherein vinyl amine is present at least during the crosslinking reaction.

43. The method according to claim 26, wherein the at least one ionizable compound is selected from the group consisting of maleic anhydride and citric acid.

44. The method according to claim 26, further comprising evaluating degree of swelling of the crosslinked polymer material in water.

45. A method of manufacturing a crosslinked polymer material, said method comprising
a) providing a hydrolysate fraction rich in at least one oligo- and/or polysaccharide, said fraction comprising 2-15 wt % lignin, and
b) modifying at least a part of the at least one oligo- and/or polysaccharide by covalently binding at least one ionisable compound to a hydroxyl group on the at least one oligo- and/or polysaccharide, wherein the at least one ionisable compound is charged at least in the pH interval from pH 5 to pH 8; and
c) crosslinking at least a part of the modified oligo- and/or polysaccharide produced in step (b).

46. The method according to claim 45, wherein said hydrolysate fraction comprises a hydrolysate based on wood.

47. The method according to claim 45, wherein said hydrolysate fraction is obtained from a process in conventional pulping.

48. The method according to claim 45, wherein the at least a part of the oligo- and/or polysaccharides are modified by reaction with an alkenyl compound.

49. The method according to claim 45, wherein the at least a part of the oligo- and/or polysaccharides are modified by reaction with N-vinylpyrrolidone.

50. The method according to claim 45, wherein the at least a part of the oligo- and/or polysaccharides are crosslinked by radical polymerization.

51. The method according to claim 45, wherein the at least a part of the oligo- and/or polysaccharides are crosslinked by ionic polymerization.

52. The method according to claim 45, wherein the at least a part of the oligo- and/or polysaccharides are crosslinked by coordination polymerization.

53. The method according to claim 45, wherein said crosslinking step c) comprises the use of a crosslinker to obtain covalent binding between the at least a part of the modified oligo- and/or polysaccharides produced in step b), and wherein an additional compound is present at least during the crosslinking reaction, said compound comprising at least one C═C double bond and at least one selected from a primary and a secondary hydroxyl group.

54. The method according to claim 45, wherein said crosslinking step c) comprises the use of a crosslinker to obtain covalent binding between the at least a part of the modified oligo- and/or polysaccharides produced in step b), and wherein an additional compound is present at least during the crosslinking reaction, said compound comprising at least one C═C double bond and at least one selected from a primary and a secondary hydrophilic group.

55. The method according to claim 45, wherein said crosslinking step c) comprises the use of a crosslinker to obtain covalent binding between the at least a part of the modified oligo- and/or polysaccharides produced in step b), and wherein acrylic acid is present at least during the crosslinking reaction.

56. The method according to claim 45, wherein said crosslinking step c) comprises the use of a crosslinker to obtain covalent binding between the at least a part of the modified oligo- and/or polysaccharides produced in step b), and wherein methacrylic acid is present at least during the crosslinking reaction.

57. The method according to claim 45, wherein said crosslinking step c) comprises the use of a crosslinker to obtain covalent binding between the at least a part of the modified oligo- and/or polysaccharides produced in step b), and wherein vinyl amine is present at least during the crosslinking reaction.

58. The method according to claim 45, wherein the at least one ionizable compound is selected from the group consisting of maleic anhydride and citric acid.

59. The method according to claim 45, further comprising evaluating degree of swelling of the crosslinked polymer material in water.

60. A crosslinked polymer material comprising covalently crosslinked oligo- and/or polysaccharides, wherein at least one hydroxyl group on said covalently crosslinked oligo- and/or polysaccharides is covalently bound to at least one ionisable compound, and wherein the at least one ionisable compound is charged at least in the pH interval from pH 5 to pH 8, and wherein said crosslinked polymer material comprises lignin.

61. The crosslinked polymer material according to claim 60, wherein the at least one ionisable compound is selected from the group consisting of maleic anhydride and citric acid.

62. The crosslinked polymer material according to claim 60, wherein the covalently crosslinked oligo- and/or polysaccharides comprise oligo- and/or polysaccharides from wood.

63. The crosslinked polymer material according to claim 60, wherein the crosslinked polymer material displays a swelling ratio (Q) of 10 or more.

64. The crosslinked polymer material according to claim 60, wherein the crosslinked polymer material is biodegradable.

65. The crosslinked polymer material according to claim 60, wherein the crosslinked polymer material is at least partly surrounded by at least one other material to form an article.

66. The crosslinked polymer material according to claim 60, wherein the crosslinked polymer material is at least partly surrounded by at least one other material when used to form an article.

67. The crosslinked polymer material according to claim 60, wherein the crosslinked polymer material is used to form an article selected from the group consisting of a sanitary product for absorbing body fluids, a diaper, an incontinence pad, a sanitary towel, a panty liner, a water filter, and a water retaining coating around a seed.

68. A sanitary product for absorbing body fluids, said sanitary product comprising the crosslinked polymer material according to claim 60.

69. A diaper comprising the crosslinked polymer material according to claim 60.

70. A method for the manufacture of at least one article selected from the group consisting of a sanitary product for absorbing body fluids, a diaper, an incontinence pad, a sanitary towel, a panty liner, a water filter, and a water retaining coating around a seed, said method involving incorporating the crosslinked polymer material according to claim 60 into the at least one article.
